(19) United States
(12) Patent Application Publication
(10) Pub. No.: US 2021/0132967 A1
(43) Pub. Date: May 6, 2021

(54) SYSTEM AND METHOD FOR CONFIGURATION MANAGEMENT DATABASE, GOVERNANCE, AND SECURITY IN A COMPUTING ENVIRONMENT

(71) Applicant: VMware, Inc., Palo Alto, CA (US)

(72) Inventor: Christopher HOPKINS, East Palo Alto, CA (US)

(73) Assignee: VMware, Inc., Palo Alto, CA (US)

(21) Appl. No.: 16/668,381

(22) Filed: Oct. 30, 2019

(51) Int. Cl. G06F 9/455; H04L 29/06; G06F 16/25; G06F 9/445; G06N 20/00

(52) U.S. Cl. CPC G06F 9/455; H04L 63/20; G06N 20/00; G06F 9/44505; G06F 16/252

(57) ABSTRACT

A Hybrid Configuration Management Database methodology is disclosed. In a computer-implemented method, components of a computing environment are automatically monitored, and have a feature selection analysis performed thereon. Provided the feature selection analysis determines that features of the components are subjectively defined, a classification of the features is performed. Provided the feature selection analysis determines that features of the components are not well defined, a similarity analysis of the features is performed. Results of the feature selection methodology are generated.

### BACKGROUND ART

A configuration Management Database (“CMDB”) refers to a system which is used to track, monitor, and update the configuration or combination of components within a configurable system, such as a computer. Such configurable systems typically have: Hardware components, such as computers, printers, servers, firewalls, network switches, routers, etc. Software components, such as operating systems, configuration files, programs, patches, and drivers. Service components, such as business applications, microservices, and integration dependencies.

Information technology Infrastructure Library (“ITIL”) is a widely accepted approach to IT service management throughout the world, which is promulgated by the United Kingdom's Office of Governance Commerce (“OGC”). ITIL employs a process-model view of controlling and managing operations. OGC works closely with public sector companies and organizations to improve a cohesive set of best practice approaches in commercial activities. ITIL's customizable framework of practices includes provisioning of information technology (“IT”) service quality, essential accommodation and facilities required supporting a proposed technology services, or the structures necessary for meeting business demands and improving IT services

CMDB is a term adopted by ITIL, and used throughout the IT profession to refer to a general class of tools and processes which are used or followed to manage the configuration of configurable systems, which are referred to as Configuration Items (“CI”) in ITIL terms. In such conventional approaches, the level of protection for the computing environment is highly dependent upon the knowledge or experience of the IT administrator. For example, an IT administrator may incorrectly choose to not register various machines or components for tracking by Configuration Management and therefore unknowingly omit proper registration of the system with an organization's IT security tools.

Moreover, as the complexity of the computing environment increases and the number of machines or components therein increases, it is highly likely that the IT administrator may unintentionally “miss” or “forget” to register certain machines or components for tracking by Configuration Management. Further, in a complex or distributed business application or machine learning service, the IT administrator may simply not be aware of the importance of particular machines or components to the application or service, and, therefore, the IT administrator will fail to list those machines or components for tracking by Configuration Management. As a result, it is possible that even important and/or extremely relevant features of an application or service may not be properly registered for appropriate governance.

According to ITIL recommendations or requirements, a CMDB is supposed to contain the latest information on all CIs for which it is applied. The CMDB data is supposed to be accurate in any given environment. In some cases the CMDB cannot be kept in synchronization with the real world system management environment since there are multiple point products involved in creating the relationship and the CIs. For example, some systems may update themselves, such as self-updating software applications, without updating or notifying the CMDB of the changes. In another example, a component of the CI may be removed, replaced, installed, or upgraded by a system administrator without updating or notifying the CMDB of the changes. As such, many CMDB records regarding particular configurable systems are only partially correct, although it is difficult to determine which details are correct and which are incorrect.

In order to support and apply governance to the IT environment that an IT organization supports, it is necessary to understand the services/applications that the business consumes (“the Service Catalog”) and how these applications depend on the infrastructure IT manages. The “textbook” ITIL approach to governance/process in the CMDB is purely a manual process—in theory one can have a complete understanding of an IT environment by knowing its starting state and the details of every change that was documented and approved; a financial-ledger approach to Configuration Management. While this is practical for a lightly controlled, low-change-rate environment like financial institutions, the approach is unsuitable for highly “agile” environments that are not subject to such stringent documentation requirements.

Some conventional approaches utilized Automated discovery to perform occasional after the fact audits, but this involves significant delay. This typically requires an audit being initiated, configuration drift must be investigated, and done with the presumption that discovered adjustments were “unapproved”, creating an adversarial relationship. Other conventional tools exist that generally attempt to generate an understanding of the environment in a fully automated way.

However, these tools provide a very raw and un-interpreted dump of current state. These are therefore unsuitable for the high level, summarized understanding of business dependencies that a CMDB would satisfy. And for discovery and monitoring of services and applications in a computing environment, constant and difficult upgrading of agents is often required. Thus, conventional approaches for application and service discovery and monitoring are not acceptable in complex and frequently revised computing environments.

Thus, even when strict configuration change processes are followed, often records in separate CMDB in the environment regarding the same CI may not be in agreement, may be partially inaccurate, and may be incompatible with being synchronized with each other.

Furthermore, the high level governance/process personnel generally will not have full knowledge of the network topology of the computing environment or understanding of the functionality of every machine or component within the computing environment. Hence, even when possible, the time and/or person-hours necessary to perform and complete such a conventionally required configuration for a system can extend to days, weeks, months or even longer.

Moreover, even when such conventionally required manual registration of the various machines or components is completed, it is not uncommon that entities, including the aforementioned very high level personnel, have failed to properly assign the proper scopes and services to the various machines or keep up with the changes that occurred during the course of the audit.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 shows an example computer system upon which embodiments of the present invention can be implemented, in accordance with an embodiment of the present invention.

FIG. 2 shows an example of a Hybrid Configuration Management Database Environment approach in accordance with an embodiment of the present invention.

FIG. 3 is shows a Hybrid Configuration Management Database, in accordance with an embodiment of the present invention.

FIG. 4 is a schematic representation of a rules engine utilized by a portfolio administrator to define patterns, known to the administrator or as recommended by machine learning algorithms, by which current and future infrastructure aligns with application portfolio or related business level concepts, in accordance with an embodiment of the present invention.

FIG. 5 is a flow diagram of the configuration implementation of the Hybrid Configuration Management Database, in accordance with an embodiment of the present invention.

The drawings referred to in this description should not be understood as being drawn to scale except if specifically noted.

### DETAILED DESCRIPTION OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

### Notation And Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “displaying”, “identifying”, “generating”, “deriving”, “providing,” “utilizing”, “determining,” or the like, refer to the actions and processes of an electronic computing device or system such as: a host processor, a processor, a memory, a virtual storage area network (VSAN), a virtualization management server or a virtual machine (VM), among others, of a virtualization infrastructure or a computer system of a distributed computing system, or the like, or a combination thereof. The electronic device manipulates and transforms data, represented as physical (electronic and/or magnetic) quantities within the electronic device's registers and memories, into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the Figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some embodiments, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Example Computer System Environment

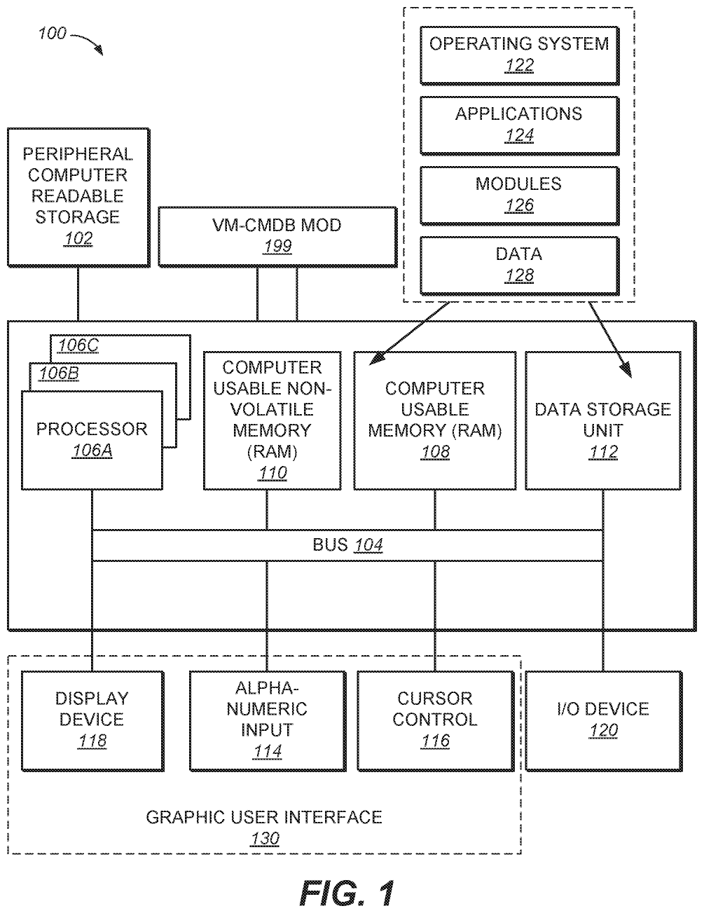

With reference now to FIG. 1, all or portions of some embodiments described herein are composed of computer-readable and computer-executable instructions that reside, for example, in computer-usable/computer-readable storage media of a computer system. That is, FIG. 1 illustrates one example of a type of computer (computer system 100) that can be used in accordance with or to implement various embodiments which are discussed herein. It is appreciated that computer system 100 of FIG. 1 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, virtual machines, virtualization management servers, and the like. Computer system 100 of FIG. 1 is well adapted to having peripheral tangible computer-readable storage media 102 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

System 100 of FIG. 1 includes an address/data bus 104 for communicating information, and a processor 106A coupled with bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 1066, and 106C may be any of various types of microprocessors. System 100 also includes data storage features such as a computer usable volatile memory 108, e.g., random access memory (RAM), coupled with bus 104 for storing information and instructions for processors 106A, 106B, and 106C. System 100 also includes computer usable non-volatile memory 110, e.g., read only memory (ROM), coupled with bus 104 for storing static information and instructions for processors 106A, 1066, and 106C. Also present in system 100 is a data storage unit 112 (e.g., a magnetic or optical disc and disc drive) coupled with bus 104 for storing information and instructions. System 100 also includes an alphanumeric input device 114 including alphanumeric and function keys coupled with bus 104 for communicating information and command selections to processor 106A or processors 106A, 106B, and 106C. System 100 also includes a cursor control device 116 coupled with bus 104 for communicating user input information and command selections to processor 106A or processors 106A, 106B, and 106C. In one embodiment, system 100 also includes a display device 118 coupled with bus 104 for displaying information.

Referring still to FIG. 1, display device 118 of FIG. 1 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 116 allows the computer user to dynamically signal the movement of a visible symbol (cursor) on a display screen of display device 118 and indicate user selections of selectable items displayed on display device 118. Many implementations of cursor control device 116 are known in the art including a trackball, mouse, touch pad, touch screen, joystick or special keys on alphanumeric input device 114 capable of signaling movement of a given direction or manner of displacement. Alternatively, it will be appreciated that a cursor can be directed and/or activated via input from alphanumeric input device 114 using special keys and key sequence commands. System 100 is also well suited to having a cursor directed by other means such as, for example, voice commands. In various embodiments, alpha-numeric input device 114, cursor control device 116, and display device 118, or any combination thereof (e.g., user interface selection devices), may collectively operate to provide a graphical user interface (GUI) 130 under the direction of a processor (e.g., processor 106A or processors 106A, 106B, and 106C). GUI 130 allows user to interact with system 100 through graphical representations presented on display device 118 by interacting with alpha-numeric input device 114 and/or cursor control device 116.

System 100 also includes an I/O device 120 for coupling system 100 with external entities. For example, in one embodiment, I/O device 120 is a modem for enabling wired or wireless communications between system 100 and an external network such as, but not limited to, the Internet.

Referring still to FIG. 1, various other components are depicted for system 100. Specifically, when present, an operating system 122, applications 124, modules 126, and data 128 are shown as typically residing in one or some combination of computer usable volatile memory 108 (e.g., RAM), computer usable non-volatile memory 110 (e.g., ROM), and data storage unit 112. In some embodiments, all or portions of various embodiments described herein are stored, for example, as an application 124 and/or module 126 in memory locations within RAM 108, computer-readable storage media within data storage unit 112, peripheral computer-readable storage media 102, and/or other tangible computer-readable storage media.

### Brief Overview

First, a brief overview of an embodiment of the present virtual machine Configuration Management Database (VM-CMDB) Model invention 199, is provided below. Various embodiments of the present invention provide a method and system for automated feature selection within a machine learning environment.

In one embodiment, there is provided a computer-based method for providing configurable item configuration data, comprising the step of receiving manually curated data from a plurality of sources and providing that to a automated configuration component that relates this information to a plurality of configuration datasets pertaining to a plurality of configurable elements.

More specifically, the various embodiments of the present invention provide a novel approach for automatically providing a classification for the various machines or components of a computing environment such as, for example, machine learning environment. In one embodiment, an IT administrator (or other entity such as, but not limited to, a user/company/organization etc.) utilizes a hybrid process of configuring system service use with corresponding virtual machines in an IT environment based on some underlying governance principle or rules. In the present embodiment, the IT administrator is not required to label all of the virtual machines with the corresponding service type or indicate the importance of the particular machine or component. Further, the IT administrator is not required to selectively list only those machines or components which the IT administrator feels warrant configuration within the system platform. Instead, and as will be described below in detail, in various embodiments, the present invention, will automatically determine which machines or components are to be configured by the system.

As will also be described below, in various embodiments, the present invention is a computing module which integrated within a virtual computing system such as, for example, the virtual machines of VMware, Inc. of Palo Alto. In various embodiments, the present Virtual machine configuration management database Model invention, will itself determine the service type and corresponding importance of various machines or components after observing the properties and activity of each of the machines or components against patterns configured by an administrator or derived through machine learning algorithms.

Importantly, for purposes of brevity and clarity, the following detailed description of the various embodiments of the present invention, will be described using an example in which the embodiments of the present hybrid VM-CMDB Model invention are integrated into virtual machine computing system environments such as, but not limited to, virtual computing platform from VMware, Inc. of Palo Alto, Calif. Importantly, although the description and examples herein refer to embodiments of the present invention applied to the above virtual configuration management systems and enterprise platforms with their corresponding functions, it should be understood that the embodiments of the present invention are well suited to use with various other types of computer systems and platforms.

Additionally, for purposes of brevity and clarity, the present application will refer to “machines or components” of a computing environment. It should be noted that for purposes of the present application, the terms “machines or components” is intended to encompass physical (e.g., hardware and software based) computing machines, physical components (such as, for example, physical modules or portions of physical computing machines) which comprise such physical computing machines, aggregations or combination of various physical computing machines, aggregations or combinations or various physical components and the like. Further, it should be noted that for purposes of the present application, the terms “machines or components” is also intended to encompass virtualized (e.g., virtual and software based) computing machines, virtual components (such as, for example, virtual modules or portions of virtual computing machines) which comprise such virtual computing machines, aggregations or combination of various virtual computing machines, aggregations or combinations or various virtual components and the like.

Additionally, for purposes of brevity and clarity, the present application will refer to machines or components of a computing environment. It should be noted that for purposes of the present application, the term “computing environment” is intended to encompass any computing environment (e.g., a plurality of coupled computing machines or components including, but not limited to, a networked plurality of computing devices, a neural network, a machine learning environment, and the like). Further, in the present application, the computing environment may be comprised of only physical computing machines, only virtualized computing machines, or, more likely, some combination of physical and virtualized computing machines.

Furthermore, again for purposes and brevity and clarity, the following description of the various embodiments of the present invention, will be described as integrated within a security system. Importantly, although the description and examples herein refer to embodiments of the present invention integrated within a security system with, for example, its corresponding set of functions, it should be understood that the embodiments of the present invention are well suited to not being integrated into a virtual computing system and operating separately from a virtual computing system. Specifically, embodiments of the present invention can be integrated into a system other than a security system. Embodiments of the present invention can operate as a stand-alone module without requiring integration into another system. In such an embodiment, results from the present invention regarding feature selection and/or the importance of various machines or components of a computing environment can then be provided as desired to a separate system or to an end user such as, for example, an IT administrator.

Importantly, the embodiments of the present hybrid configuration management database module invention significantly extend what was previously possible with respect to providing manual configuration management computing for machines or components of a computing environment and an automated configuration of the machines or components. Various embodiments of the present hybrid configuration management Model invention enable the improved capabilities while reducing reliance upon, for example, the retained or legacy knowledge of an IT administrator, to selectively register various machines or components of a computing environment for security protection and monitoring. This is in contrast to conventional approaches for providing configuration management by either using a manual approach entirely with all the associated deficiencies of the accuracy of information, the tribal and siloed nature of computing environments and the fully automated approaches which tend to be static and rigid in the management and utilization of resources in such environment. Thus, embodiments of present hybrid configuration management database Model invention provide a methodology which extends well beyond what was previously known.

Also, although certain components are depicted in, for example, embodiments of the Hybrid Configuration Management Database Model invention, it should be understood that, for purposes of clarity and brevity, each of the components may themselves be comprised of numerous modules or macros which are not shown.

Procedures of the present Hybrid Configuration Management Database Model invention are performed in conjunction with various computer software and/or hardware components. It is appreciated that in some embodiments, the procedures may be performed in a different order than described above, and that some of the described procedures may not be performed, and/or that one or more additional procedures to those described may be performed. Further some procedures, in various embodiments, are carried out by one or more processors under the control of computer-readable and computer-executable instructions that are stored on non-transitory computer-readable storage media. It is further appreciated that one or more procedures of the present may be implemented in hardware, or a combination of hardware with firmware and/or software.

Hence, the embodiments of the present Hybrid Configuration Management Database Model invention greatly extend beyond conventional methods for providing configuration management in accordance to established governance principles and security to machines or components of a computing environment. Moreover, embodiments of the present invention amount to significantly more than merely using a computer to provide conventional configuration management and security measures to machines or components of a computing environment. Instead, embodiments of the present invention specifically recite a novel process, necessarily rooted in computer technology, for a hybrid mechanism of configuration management of computing resources in a large scale virtual computing environment in accordance to established governance principles within the environment.

Furthermore, in various embodiments of the present invention, and as will be described in detail below, a security system, such as, but not limited to, virtual computing devices from VMware, Inc. of Palo Alto, Calif. will include novel security and configuration solution for a computing environment (including, but not limited to a data center comprising a virtual environment). In embodiments of the present invention, unlike conventional security systems which “chases the threats” by depending on fallible communication processes to describe the intended state to be monitored, the present security system will instead focus on dynamically inferring the intended states of applications, machines or components of the computing environment, and the present security system will raise alarms if any anomaly behavior is detected or any hygiene issues are found that suggest the current understanding of the environment is incomplete or out of date.

Additionally, as will be described in detail below, embodiments of the present invention provide a hybrid approach including a novel search feature for machines or components (including, but not limited to, virtual machines) of the computing environment. The novel search feature of the present security system enables ends users to be readily assigned the proper and scopes and services the machines or components of the computing environment, Moreover, the novel search feature of the present system enables end users and system administrators to identify various machines or components (including, but not limited to, virtual machines) similar to given and/or previously identified machines or components (including, but not limited to, virtual machines) when such machines or component satisfy a particular given criteria. Hence, as will be described in detail below, in embodiments of the present configuration management system, the novel search feature functions by finding or identifying the “siblings” of various other machines or components (including, but not limited to, virtual machines) within the computing environment.

Continued Detailed Description of Embodiments after Brief Overview

As stated above, feature selection which is also known as “variable selection”, “attribute selection” and the like, is an import process of machine learning. The process of feature selection helps to determine which features are most relevant or important to use to create a machine learning model (predictive model).

Embodiments of the present Hybrid Configuration Management Database Model invention utilize a combined manual curation and automated approach to determine the importance of resource utilization and allocation to end-users in a particular business service within, for example, a computing environment.

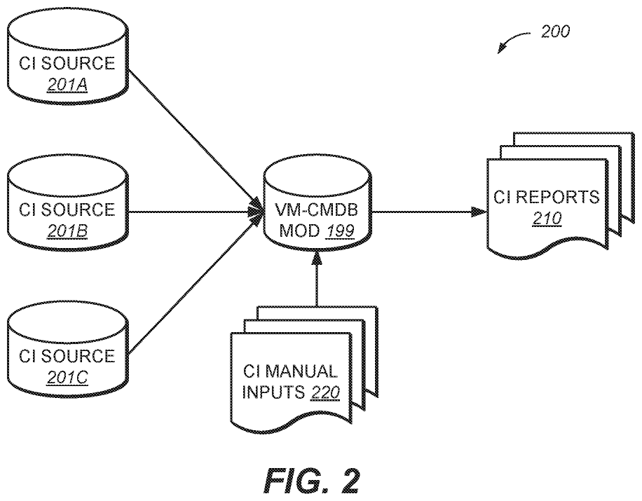

With reference now to FIG. 2, in embodiments of the present invention, the Hybrid Configuration Management Database environment, within a large scale virtual computing environment is determined as follows. The virtual computing environment comprises a plurality of configuration items (CIs) given

More specifically, the various embodiments of the present invention provide a novel approach for automatically providing a classification for the various machines or components of a computing environment such as, for example, machine learning environment. Further, unlike conventional approaches, in embodiments of the present Model invention, the IT administrator is not required to label all of the virtual machines with the corresponding service type or indicate the importance of the particular machine or component solely based on the retained or legacy knowledge of the administrator. Further, the IT administrator is not required to selectively list only those machines or components which the IT administrator feels warrant configuration in the environment knowing the subjective discoveries of business level services, etc. protection from the security system platform. Instead, the present invention, will manually take curated data and automatically determine the importance of the various features within the computing environment as explicitly described above in conjunction with the discussion of FIGS. 1 and 2.

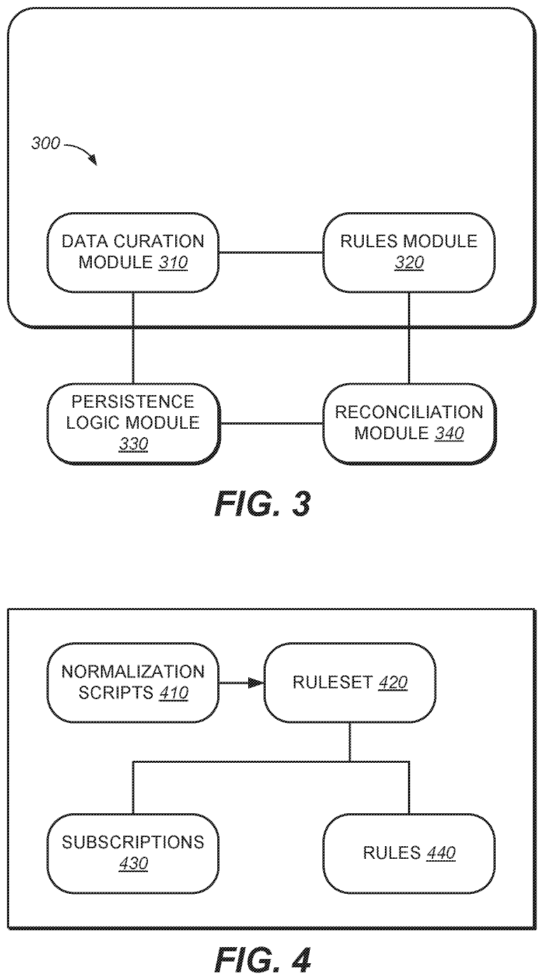

With reference now to FIG. 3, in one embodiment of the present invention, the Hybrid configuration Management Database Module of the present invention comprises a data curation component 310, a rules component 320, a cascading persistence logic component 330 and a reconciliation component 340. In one embodiment, for example, the present Hybrid Configuration Management Database Module 199 of FIG. 2 is implemented by providing a combined manual and automatic processing of resource allocation and usage pursuant to certain governance principles in a large scale virtual computing environment.

In one embodiment, the hybrid solution includes a manual data curation endeavor of manually identifying external resources in the computing environment and their corresponding relating services provision and utilization to determine whether these resources are optimally being utilized within the computing environment. The manual approach is combined with an automated configuration management of resources, including infrastructure, software, applications, and business services to ensure that the proper external resource is allocated to the corresponding proper business service.

Further, in various embodiments of the present Hybrid Configuration Management Database Module invention, as shown in FIG. 3, the embodiments will either continuously or periodically continue to automatically determine the importance of the various features and business resources within the computing environment as explicitly described in the underlying governance of the environment. To ensure that conflicts in how a business services end-user actually utilizes resources in the environment vis-à-vis how the computing system shows as utilization, the Hybrid Configuration Management Database Module provides resource utilization reports as shown in FIG. 2 to allow system administrators across multiple disciplines to access the same data. This eliminates or minimizes the need for “tribal” or “institutional” knowledge in the management of resources in the computing environment.

Still referring to FIG. 3, in one embodiment, the HCMDB 199 meets the needs that a CMDB would normally meet in terms of enabling cross-silo visibility among various administrator teams within the computing environment and a central taxonomy so everyone (governance, applications and infrastructure teams) is all working out of the same end-to-end data even within an environment that is “hide and seek” rather than “command and control”.

In one embodiment of the present invention, an open collection of data and information is implemented to pull and push information from any suitable data source, e.g., if a user can write a script to pull in the data it should be fully usable in the environment on equal stand with default collection methods.

In one embodiment, all layers of the present invention seamlessly adapt to new data types, properties and relationships—if a particular user group wants to start collecting and presenting a new attribute on their inventory, this is achievable without any invasive schema changes.

In one embodiment of the present invention, unlike existing conventional solutions which require a centralized control of inventory collection-centralized management of administrative credentials, a centrally managed collection, etc., approaches that are suitable for a centralized computing environment but unsuitable for a decentralized environment, the present invention assumes read-only access to the resources in the environment and does not require any changes to the normal process (naming conventions, etc.) in the computing environment. This also enables system administrator silos to control their own credentials and collection processes if desired, collecting data when they choose and pushing what they choose.

Still referring to FIG. 3, the data curation module 310 enables a systems administrator to manually collect data and information on resources in the environment. In one embodiment, the data manually collected is restricted to subjective, non-discoverable concepts only centering around a “application” portfolio and the organizational units and subjective criteria such as compliance requirements that the portfolio should be tracked against.

The rule definition module 320, in one embodiment of the present invention, is utilized to enable the portfolio administrator to define known patterns by which current and future infrastructure aligns with the application portfolio or related business-level concepts e.g., sever naming conventions, detected software products, etc. The latest infrastructure inventory from the computing environment can then be processed against these rules to ensure that configuration drift may be captured in a structured reportable way in the report generation module in FIG. 2.

The cascading persistence module 330 of the present invention is applied to asynchronous inventory record collection in the computing environment. In one embodiment, the cascading persistent component 330 is applied in an attempt to recognize when a single uniquely identifiable configuration item (CI) moves from one source to another. This allows the history and relationships of the items to be persisted in the repository even when no single ID property exists. In one embodiment, much of the data in the repository comes from external sources, for example virtual machine lists (VM list) comes from the virtual data center (vCenter). We track the Server nodes in the present invention relative to the data from that vCenter so that changes to the VM in vCenter are consistently reflected as the same VM in the hybrid configuration management database of the present invention. However, sometimes a VM can move from one vCenter to another. There is still the need to persist it as the same VM so the system can preserve the history, relationships, etc. The challenge is there is no single ID field appropriate for both cross-vCenter migrations and sustained tracking over time within a vCenter. The present invention generalizes this to a non-vCenter-specific approach for any cases for where CIs can migrate across external “sources of truth”. This embodiment uses these additional node attributes: datasource to indicate the name of the external source of truth; external_id to track the primary external unique ID for the object (as long as something with this ID still exists, it will be used); fallback_id as an optional alternate external ID, used only when external_id fails to find a match; pending_datasource to track pending adds where the asynchronous collection model (both sides of the CI migration must provide data before the system can determine what happened, but their data does not arrive simultaneously) requires information from the other, potentially conflicting datasource to determine whether it was a move or a copy and the final decision must be deferred to a future collection job.

Still referring to FIG. 3, the reconciliation module 340 is applied to discovered data allowing overlapping and sometimes contradictory discovery sources to be ranked so that the best available source is used, thereby ensuring that the system is able to provide a simple enough abstract view of the computing environment without overwhelming users with raw, unharmonized data.

With reference next to FIG. 4, a schematic diagram of an embodiment of the rules module component 320 of one embodiment of the present invention is provided. In FIG. 4, the rule module component 320 comprises a normalization component 410, a ruleset component 420, a subscription component 430 and a rules component 440.

In one embodiment, the normalization component 410 comprises a software script implemented by pulling an inventory payload, iterating through it, and performing a pull/transform/push sequence on each node specified in the payload. In one embodiment, some of the transformation will be inherent to the payload type, such as establishing relationships between cluster, a virtual machine host (VMHost) and server nodes in the virtual computing environment (vCenter).

However, much of the transformation is rule based on the rules 440. The intention is that there are sets of rules that each define conditions and an output value when the conditions are met and then specific normalization processes can be subscribe to these rule sets and map their output to specific node properties or relationships.

In one embodiment of the present invention, the top-level object is called a ruleset 420 which defines the basic metadata and contains a list of subscriptions 430 and a list of rules 440. An exemplary software code of the ruleset is shown below:

```
    [{
        “ruleset_id” : “r001”
        “ruleset_name”: “get-server-environment”,
        “description”: “Given inputs “Cluster’ and ‘name’, this ruleset
will determine the value of an ‘environment’ attribute.”,
      “subscriptions”: [ ],
      “ rules”: [ ]
  } ]
```

Still referring to FIG. 4, subscriptions 430 are how the ruleset 420 gets applied. Every payload provided to the HCMDB 199 in a virtual computing environment has a type: vCenter or vCloud Director payloads, for example, are submitted as “ServerList” payloads that will get processed by a “ServerList” normalization script. These scripts pull a list of all rulesets they are subscribed to, and will use them as described by the subscription details: passing in the attributes “Cluster” and “name” and storing the output into an attribute called “environment”. There must be at least one subscription or the ruleset 420 will never be applied anywhere. In the exemplary code set forth below the server's “name” and “cluster” attributes (which are obtained from the vCenter) are used to determine a new “environment” attribute, i.e., is this virtual machine (VM) considered “production” or “non-production”.

```
[ {
  “subscriber”: “ServerList”,
  “for_nodetype”: “Server”,
  “inputs”: [
      “Cluster”,
      “name”
    ],
  “output”: “environment”,
  “comment”: “ “
}]
```

In reference to FIG. 4, the rules component 440 takes inputs that are passed and evaluate them against various conditions. A rule can have more than one condition. If so, they can be evaluated with “and” so that all conditions must be true, or with “or” so that only a single condition needs to be true. Once a condition evaluates as true, the return value is passed back to the subscriber 430 with a score and no more rules from that set will be evaluated for that output value on that node. However, a subscriber 430 can use more than one ruleset 420 for a given node type and output in the case all the ruleset will be evaluated and the highest-scoring value will be used. In the exemplary code set forth below, the present invention contemplates an instance where anything where the cluster name includes “Prod” or the server name includes “prod” or “prd” to be “Production” and anything else (the final rule) will be considered “Non Production”.

In one embodiment of the present invention, every rule must have a sequence that determines the order in which they are evaluated. The rule must also have conditions which are an array of options of objects with variable, op(operator), and value fields. Allowed operators include: like, not like, regex, is, is not. If no conditions are provided the rule will always evaluate as true. If more than one is provided, the condition logic field (and/or) will determine whether the entire rule evaluates as true. The rule further includes a score if the subscriber is using multiple competing rulesets on the same attribute, the one providing the highest score will be used. A result action/value in included in the rule. In one embodiment, certain options are available. These options include “return string” which returns the literal string from the value field, “return variable” which returns the original value of the variable named in the value field, “titlecase” returns the variable but converts it to “TitleCase”, e.g., “xyz” is converted to “Xyz”. Additionally, a “return node” option is included if the output is to be used as a relationship rather than an attribute.

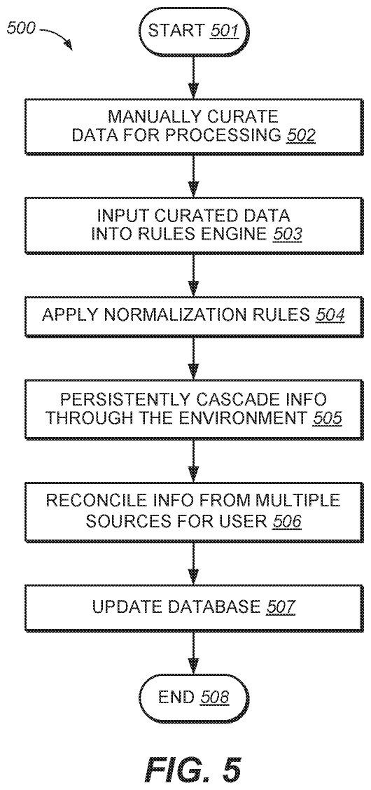

With reference now to FIG. 5, a schematic representation of a workflow 900 (also referred to as a method of performance) of operations performed by an embodiment of the present novel virtual machine (VM) hybrid configuration management database module 199 is provided. It should be noted that although the operations of workflow 500 are depicted in a certain order in FIG. 5, embodiments of the present invention may perform the various operations in an order which differs from the order of workflow 500. Additionally, in various embodiments of the present inventions, various operations may be added to workflow 500, and various of the operations in workflow 500 may be omitted.

Still referring to workflow 500 of FIG. 5, at 501, in one embodiment of the present invention, Data from a Data Curation step 502 is provided to the HCMDB 199 for processing. In the Step 502, data is manually curated from the user environment to gather subjective non-discoverable concepts relevant to Application Portfolio Management. These subject data may include: what a business service-level processes are; what compliance requirements are; who the business service belongs to, contacts who should be associated with the application, costs associated with the application, etc. In one embodiment, the data is gathered by interviewing the users in a particular business unit or organization, who know the needs and usage of a given application in the portfolio.

At Step 503, the manually curated data is presented to the automated portion of the present invention to be automatically processed. At Step 503 the curated data is applied into a rules engine component. The rules engine component at Step 503 is applied so that a systems administrator can define the known pattern by which current and future infrastructure aligns with the application portfolio or related business level concepts.

At Step 504, normalization rules are applied to the collected data in the rules engine component. In one embodiment.

At step 505, a cascading persistence logic is applied to the curated data. The cascading persistence logic is applied in an attempt to recognize when a single uniquely-identifiable configuration item moves from one physical or virtual location or one external data source to another. The cascading persistence logic step 505 is important to maintain the history and relationships of the configurable items.

At Step 506, a reconciliation process is applied to discovered data from Step 502, allowing overlapping and sometimes contradictory discovered sources to be ranked to determine the best-available resource being used. The reconciliation step 506 provides the user with a summarized view of the computing environment without overwhelming the user with raw data. And at Step 507, the database is updated with the information garnered from the process of the present invention.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for automated tracking and governance of resources in a computing environment, said method comprising:
automated discovery of components of said computing environment;
receiving manually curated subjective, non-discoverable data centering around an application portfolio, business context, and organizational units in the computing environment;
defining known patterns by which current and future discovered infrastructure components align with said application portfolio of said computing environment;
performing a cascading persistence identification to determine when a single, uniquely-identifiable configuration component moves from one data source to another; and
reconciling the configuration components from multiple overlapping data sources and harmonizing the raw data to ensure use of the best available data from said computing environment.

2. The computer-implemented method of claim 1 wherein said curating data is manually performed.

3. The computer-implemented method of claim 2 wherein said curating comprises generating non discoverable user knowledge pertaining to a particular application portfolio in said computing environment.

4. The computer-implemented method of claim 1 wherein said performing a cascading persistence identification comprises performing a cascading persistence to identify data in an asynchronous inventory record collection in the computing environment.

5. The computer-implemented method of claim 4 wherein said performing a cascading persistence identification tracks name change events and cross data center migration of the application portfolio in the computing environment.

6. The computer-implemented method of claim 1 wherein said defining known patterns by which current and future infrastructure aligns with the application portfolio comprises applying a ruleset of defined rules for processing configurable items of said computing environment.

7. The computer-implemented method of claim 6 wherein said processing of configurable items assures capturing of configuration drifts in a structured reportable manner for system administrators of said computing environment.

8. The computer-implemented method of claim 7 wherein said rules processing of the collected data further comprises performing a normalization of data payload and iterating through it and performing a pull/transform/push sequence on each node specified in the payload of said configurable components of said computing environment.

9. The computer-implemented method of claim 8 wherein said rules processing further comprises a subscription process for determining how said ruleset is applied to the configuration components of said computing environment.

10. The computer-implemented method of claim 9 wherein the rules takes inputs from the configuration components and evaluates them against various conditions of said computing environment.

11. The computer-implemented method of claim 10 further comprising:
providing said updated results of said automated analysis of said features of said components of said computing environment to a configuration management database.

12. A hybrid configuration management database system, comprising:
curating subject non-discoverable data from users of configuration items in a virtual computing environment;
automatically processing the curated data by applying a set of rules to evaluate against conditions in the virtual computing environment to determine how the infrastructure relates to the curated data without requiring intervention by a system administrator.

13. The hybrid configuration management database system of claim 12 wherein the automatic processing of curated data further comprises performing cascading persistence to iterate through configurable items in the virtual computing environment to ensure that identified configuration items preserve all the attributes that relate to a particular application portfolio entry in the curated data.

14. The hybrid configuration management database system of claim 13 wherein the curated data is manually gathered from user communities of the configuration items within the virtual computing environment.

15. The hybrid configuration management database system of claim 13 wherein said performing automated analysis further comprises a similarity analysis of said curated data of said application portfolio of said computing environment to determine related relationships to configurable configuration items.

16. The hybrid configuration management database system of claim 15 further comprising perform a cascading persistence process to support asynchronous inventory collection of records of said components of said computing environment.

17. The hybrid configuration management database systems of claim 16 further comprising reconciling analysis the curated data with configuration items in the computing environment to provide a summary high-level view of the computing environment to the end-user.

18. The hybrid configuration management database system of claim 17 wherein said reconciling analysis the curated data further comprises scoring available configuration items to determine the best available information to provide relative to the curated data.

19. The hybrid configuration management database system method of claim 18 wherein said providing results for said reconciling analysis of said features of said components of said computing environment further comprises:
providing said results to a security system.

20. The hybrid configuration management database system of claim 19 further comprising:
periodically repeating said automated analysis of said features in said computing environment to generate updated results of said automated analysis of said features of said components of said computing environment.
